(19) United States
(12) Patent Application Publication
(10) Pub. No.: US 2013/0061815 A1
(43) Pub. Date: Mar. 14, 2013

(54) Interactive pet product with squeaker

(71) Applicant: Raad Mobrem, Santa Ana, CA (US)

(72) Inventor: Raad Mobrem, Santa Ana, CA (US)

(73) Assignee: Durable Ideas

(21) Appl. No.: 13/199,755

(22) Filed: Sep. 8, 2011

(51) Int. Cl. A01K 29/00

(52) U.S. Cl. 119/707

(57) ABSTRACT

A multipurpose durable pet toy including an interactive treat dispensing portion along with a squeaker or noise toy portion, and also serving as a chew toy, and fetch toy involving pets and for play involving pets and people, useful for entertaining the pet while stimulating the mind and rewarding with treats. The toy includes at least two joined but isolated chambers, which may be of shapes including but not limited to: a hollow spherical, cube, cuboid, or cylinder, or any hollow polygonic shape. At least one chamber includes a soundhole/aperture for squeaker or noise maker placement, that is attached to but isolated from at least one second chamber. The second chamber includes at least one aperture for treat insertion and dispensing.

### RELATED APPLICATIONS

Not Applicable

### FEDERALLY SPONSORED RESEARCH

Not Applicable

### SEQUENCE LISTING

Not Applicable

### BACKGROUND OF THE INVENTION

The invention relates to durable pet products (pet toys) which incorporate multiple chambers into one object for a multipurpose toy and treat dispenser and more particularly, to pet toys having molded sections made from a rubber or TPE or any strong elastic material that allow for its shape to be deformed and reinstated to its original shape allowing an acoustic squeaker or noise maker to work properly and treats to be removed from an aperture.

Pet toys exist constructed from elastic rubber-like material materials that make noise or squeak when deformed by a pet, most typically a dog for these types of toys, so “pet” and “dog” will be used interchangeably herein. There are also pet toys for the purposes of interaction with the dog and to reward the dog by dispensing treats or food when the toy is oriented in a certain position or deformed in a certain way. Because of the specific characteristics of these toys, dogs become intrigued and willing to interact with the toys.

One distinct disadvantage with these toys is that many dogs are not willing to engage in play with a toy that only offers one means of interaction. For instance, there are many dogs that are very enticed to play with a squeaker toy due to the noise that is made from the toy, but due to the nature of the dog not enticed to play with a toy that dispenses treats. There are also many dogs that are very enticed to play with a treat-dispensing toy due to smell or aroma of the treats within the toy, but due to their natures not enticed to play with a toy that makes noise. Other dogs may require more than one source of enticement to attract and hold their interest.

Existing pet toys generally only have one chamber that does not allow for dual-features such as squeaker or noise making and treat dispensing portions. As a result, most pet owners have multiple toy types, which tend to lack universal appeal to all pets at all times.

Although existing toys are serviceable for many instances, a need exists for a durable pet toy that has multiple features: chew toy, fetch toy, squeaker or noise maker, and treat dispensing toy to help keep a pet engaged or entertained. Furthermore, a need exists for a molded multi-cavity durable toy for the purposes of combining and allowing the squeaker or noisemaker portion and the treat-dispensing portion to be connected as one item.

### BRIEF SUMMARY OF THE INVENTION

The invention is an interactive pet toy including at least one first chamber with a sound hole, sized to contain a predetermined range of floating squeakers, at least one floating squeaker, and at least one second chamber, isolated from the first chamber with at least two apertures, one sized for a close fit to a predetermined range of dog treats, and one sized as a suction relief vent. The toy is constructed of suitable material or materials where the squeaker chamber is compressible and sized to provide compressible reaction to pets to activate the squeaker, and the treat chamber is made of compressible or non-compressible materials and sized to allow a pet to remove treats from the treat aperture. One suitable material is molded TPE.

In a preferred embodiment, the squeaker is selected to be compressible in an installable state to fit within the sound hole and then expands in an operational state captured within the first chamber.

In another embodiment the invention includes a plurality of bumps configured to provide interesting bounce behavior. For one particular version, the toy is formed into a shape representing a fanciful creature and the bumps may be legs, ears and the like. Iona preferred embodiment, the squeaker is totally encompassed within the first chamber and has no contact with the surface or exterior of the toy.

### BRIEF DESCRIPTION OF THE DRAWINGS

The invention will be better understood by referring to the following figures.

FIG. 1 shows various views of one embodiment of the invention.

FIG. 2 illustrates various detailed features of the invention.

FIG. 3 illustrates the configuration of the squeaker in one embodiment of the invention.

### DETAILED DESCRIPTION OF THE INVENTION

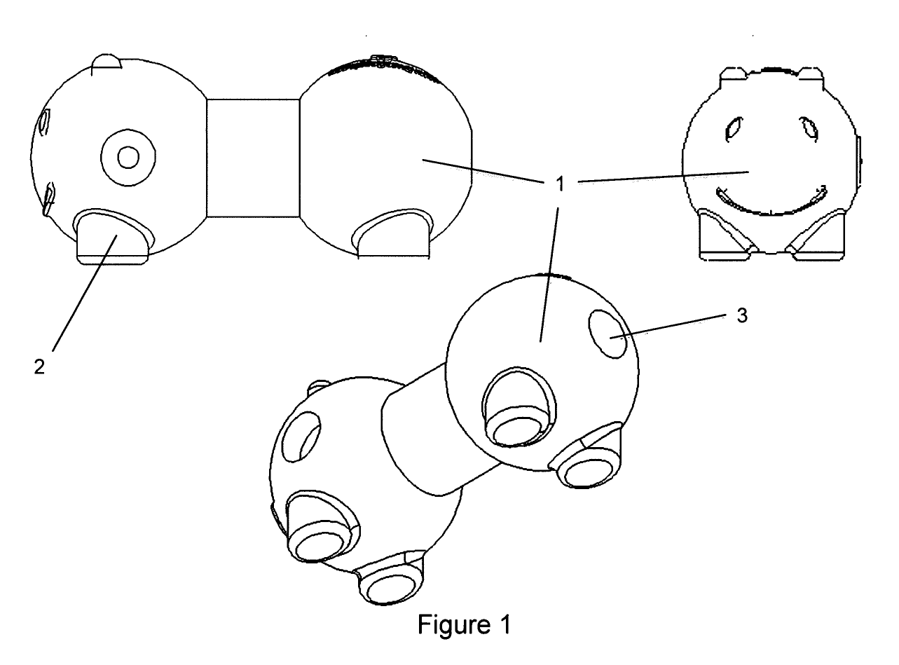

In accordance with the present invention, a pet toy is provided which incorporates multiple chambers for the purposes of dual features: noise making and squeaking and treat dispensing. By way of example, the pet toy may be shaped with two or more different chambers in the shape of a hollow spherical or hollow cube or hollow cuboid or hollow cylinder or any hollow polygonic shape, connected by another portion that also has any polygonic shape, whether it is hollow or not. Other multiple chamber arrangements will suggest themselves to one skilled in the art and fall within the scope of the invention. In one example, shown in the drawings, the chambered sections and joining sections may be shaped in the form of a fanciful creature as shown in FIG. 1, as two spheres with animal features joined by a cylinder. Such a shape is shown by way of example only and is not limiting in any way. In the figure the toy 1 has bumps 2, which for the creature shape may be in the form of legs or ears. These bumps add to the attraction of the toy by making it bounce in a more interesting way when thrown about by a pet. A sound hole/squeaker toy aperture 3 is also shown.

The pet toy is preferably constructed of one material; but the toy can use different materials in different sections for better construction and durability. The squeaker chamber needs to be compressible while the treat chamber may or may not be compressible and will still function. Preferable materials for at least the squeaker portion of the present toy include natural rubber, plastic, synthetic rubber, or any combination of two or more rubber-like materials such as TPE and its variants.

The invention is related to the pet industry and is a pet toy. The toy presented today is best described as an interactive pet toy with a squeaker that has the purpose of entertaining the animal with noise and food searching capabilities. The toy has the dual purpose of an interactive toy for dogs or any animal and also a squeaker toy for dogs or any animal. It should be made of materials that are elastic and allow for a dog to squeeze the toy. The toy allows for treats to be deposited into the toy and then be dispensed after the dog engages with the toy in the correct manner. The toy also squeaks or makes noise when the dog interacts with it.

Thus one portion of the toy allows for food or food treats or anything that is perishable to be inserted into the toy. Once a dog or any animal interacts with the toy in the correct manner, those treats would fall out rewarding the dog or animal. The toy also includes a squeaker that makes a noise when the dog or animal interacts with the toy correctly. For instance, one type of squeaker toy involves the dog to squeeze the toy and when the toy decompresses, it releases air through the squeak device creating a noise. A variety of suitable squeaker devices are known in the art.

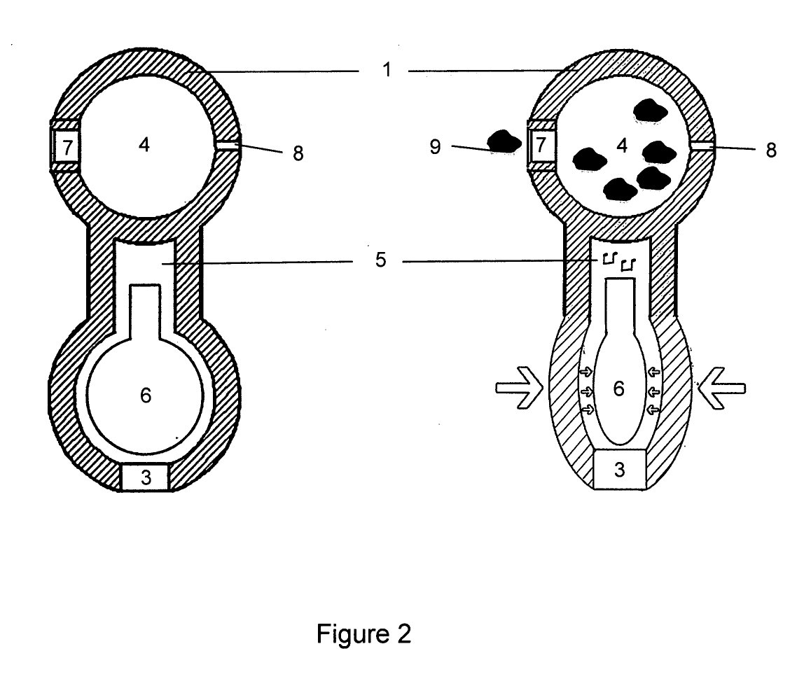

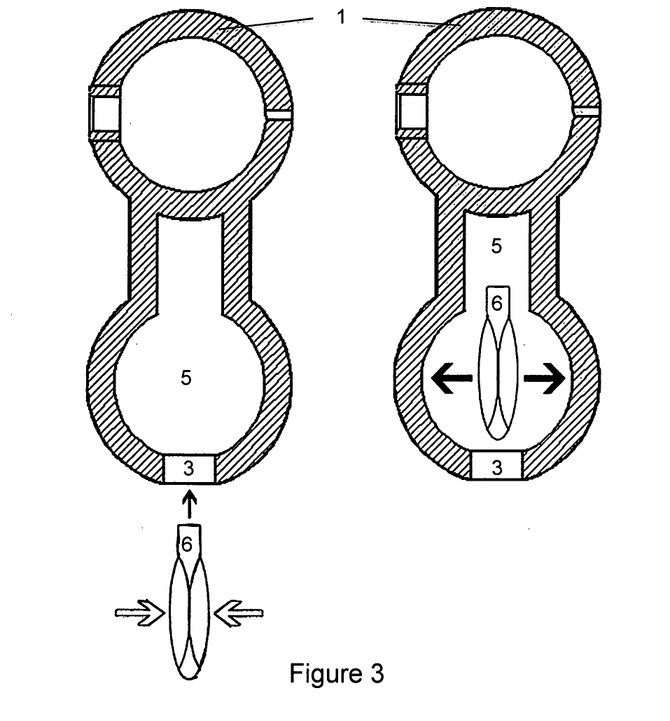

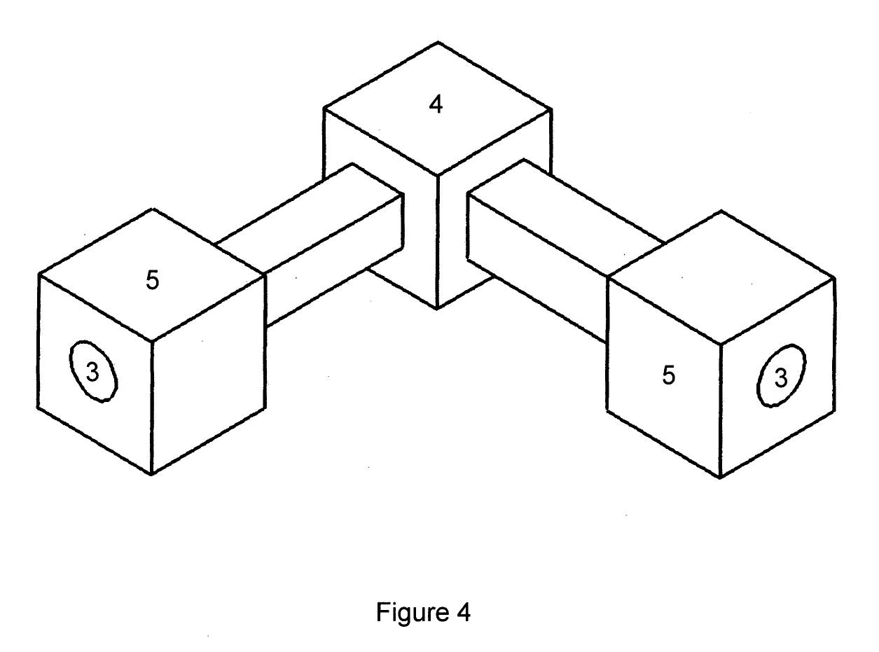

Turning to FIG. 2 details of the toy 1 are shown, again for the case where the invention takes the shape of two hollow spheroids connected by a cylinder. Two chambers 4 and 5 are shown although more chambers may be employed. Chamber 4 is for treats 9. Aperture 7 (more than one treat aperture may be used) is sized such that treats of a predetermined size may be pressed through the elastic aperture 7 and retained in chamber 4. When a pet interacts with the toy worrying at the structure allows for extraction of treats 9. At least one second, preferably smaller aperture 8 is required for safety as a suction relief, to prevent a pets tongue from being trapped in aperture 7 when compressing the toy.

Chamber 5 is isolated from chamber 4 to prevent treat detritus from contaminating the squeaker 6. Squeaker 6 is of a floating type and sized to fit within the chamber 5. Sound hole and squeaker installation aperture 3 is shown. A pet compressing chamber 5 will squeeze the squeaker 6 and produce noise.

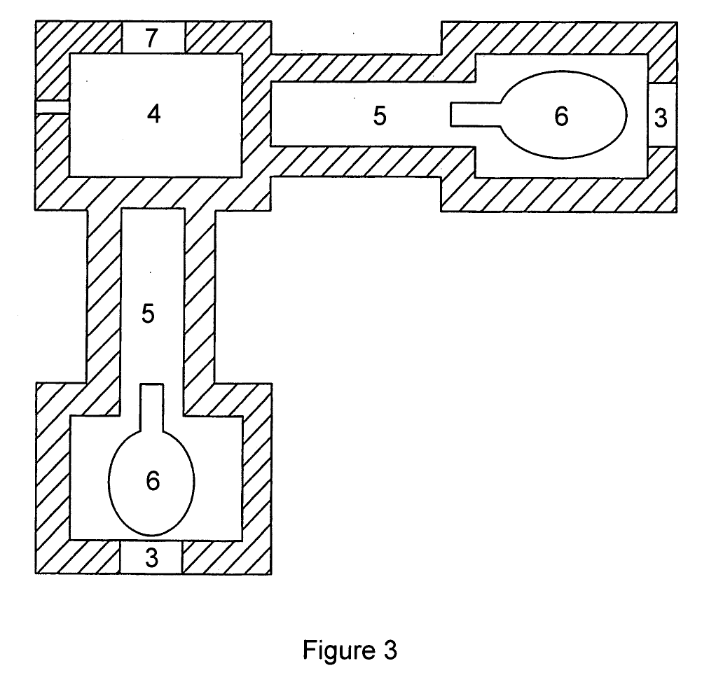

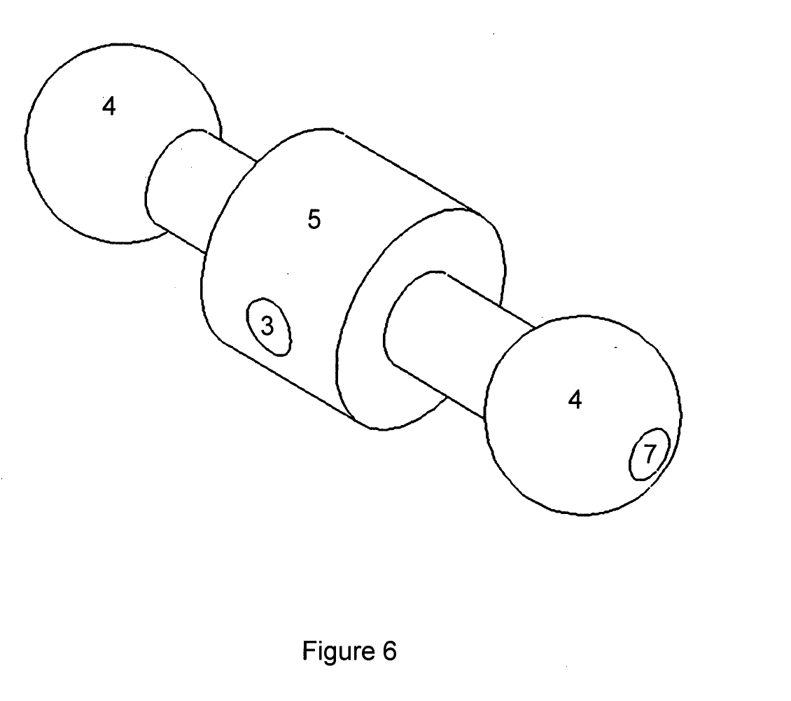

Referring to FIG. 3, a particular arrangement for squeaker 6 is shown. Squeaker 6 is selected to be highly compressible in a non-operational state to fit within aperture 3. When place inside the chamber 5, squeaker 6 expands to an operational state which is large enough to be captive within the chamber 5. Because the squeaker 6 is floating and the walls of the chamber 5 hold floating squeaker, there is no need for the squeaker to be present at the surface of the toy. Most toys have the squeaker device showing at the surface for air to travel in and out of the chamber. This provides a hazard as the dog can easily ply the squeaker out and potentially choke on the device. The novel toy reduces the chances of this happening significantly because a durable material is used that fully encompasses the squeaker.

FIGS. 4, 5 and 6 illustrate that different combinations of numbers and shapes of chambers 4 and 6, squeakers 6 and apertures 3 and 7 are possible and fall within the scope of the invention.

The foregoing description of the embodiments of the present invention has shown, described and pointed out the fundamental novel features of the invention. It will be understood that various omissions, substitutions, and changes in the form of the detail of the systems and methods as illustrated as well as the uses thereof, may be made by those skilled in the art, without departing from the spirit of the invention. Consequently, the scope of the invention should not be limited to the foregoing discussions, but should be defined by appended claims.

1. An interactive pet toy comprising;
at least one first chamber with a soundhole, sized to contain a predetermined range of floating squeakers,
at least one floating squeaker; and,
at least one second chamber, isolated from the first chamber with at least two apertures, one sized for a close fit to a predetermined range of dog treats, and one sized as a suction relief vent, wherein;
the toy is constructed of suitable materials where at least the first chamber is sized and made from a material to provide compressible reaction to dogs to activate the squeaker, and at least the second chamber is made from a material to allow a dog to remove treats from the treat aperture.

2. The toy of claim 1 wherein the squeaker is selected to be compressible in an installable state to fit within the soundhole and then expands in an operational state to be captured within the first chamber.

3. The toy of claim 1 further comprising at a plurality of bumps configured to provide interesting bounce behavior.

4. The toy of claim 1 wherein the squeaker is totally encompassed within the first chamber and has no contact with the surface or exterior of the toy.
